(19) United States
(12) Patent Application Publication
(10) Pub. No.: US 2005/0250355 A1
(43) Pub. Date: Nov. 10, 2005

(54) Hinge structure and electronic apparatus

(75) Inventor: Yung Kun Lin, Taipei (TW)

Correspondence Address: BIRCH STEWART KOLASCH & BIRCH, PO BOX 747, FALLS CHURCH, VA, 22040-0747, US

(73) Assignee: ASUTeK COMPUTER INC.

(21) Appl. No.: 11/105,352

(22) Filed: Apr. 14, 2005

(30) Foreign Application Priority Data
May 5, 2004 (TW) 093112698

(51) Int. Cl. H01R 12/00

(52) U.S. Cl. 439/76.2

(57) ABSTRACT

A hinge structure is for connecting a first machine body and a second machine body. The hinge structure includes a supporting bracket, a first connecting assembly, and a second connecting assembly. In this case, the supporting bracket has a first portion and a second portion. The first connecting assembly has a third portion and a fourth portion. The third portion connects with the first portion. The fourth portion is fixed with the first machine body. The supporting bracket and the first connecting assembly rotate to each other with a first rotational axis. The second connecting assembly has a fifth portion and a sixth portion. The fifth portion connects with the second portion. The sixth portion is fixed with the second machine body. The supporting bracket and the second connecting assembly rotate to each other with a second rotational axis.

### BACKGROUND OF THE INVENTION

1. Field of Invention

The invention relates to a hinge structure and an electronic apparatus, and, in particular, to a hinge structure, which is for adjusting the display angle of the electronic apparatus, and an electronic apparatus with the hinge structure.

2. Related Art

Among the variety of information products, the notebook has been chosen by many people. The best advantage of the notebook is its portability, which allows the user to take it everywhere. As the progress and the improvement of the technology, a notebook is just like a walking station. Through the notebook, the users can access and transmit the useful information and control a database. It is the best weapon to realize the mobile office. The designing of the notebook is not only considered on the installed software but also on the operation humanity, which includes the convenience of interface connection, weight, workability, and so on.

Referring to FIG. 1, the notebook 1 mainly includes a mainframe 11, a liquid crystal display 12, and a hinge structure 13. After opening the liquid crystal display 12 for operation, if the user feels the liquid crystal display 12 is not in the right angle, he/she can adjust the opening angle between the liquid crystal display 12 and the mainframe 11 by the hinge structure 13 disposed between the liquid crystal display 12 and the mainframe 11. Then the user can see more clearly on the liquid crystal display 12.

However, the conventional notebook 1 uses the hinge structure 13 between the mainframe 11 and the liquid crystal display 12 as a pivoting point. By adjusting the opening angle of the liquid crystal display 12, the view scope of the user can be adjusted. This method can adjust only the opening angle, and the relative distance or height between the mainframe 11 and the liquid crystal display 12, however, can not be adjusted. As a result, the user's view is limited and the user can not have a better viewing angle and relative distance, which provides insufficient convenience.

As described above, it is an important subject to provide a hinge structure and an electronic apparatus for solving the above-mentioned problems.

### SUMMARY OF THE INVENTION

In view of the foregoing, this invention is to provide a hinge structure and an electronic apparatus for adjusting the distance and the relative height between the display and the mainframe.

To achieve the above, the invention provides a hinge structure for connecting a first machine body and a second machine body. The hinge structure includes a supporting bracket, a first connecting assembly, and a second connecting assembly. In the invention, the supporting bracket has a first portion and a second portion. The first connecting assembly has a third portion and a fourth portion. The third portion connects with the first portion. The fourth portion is fixed with the first machine body. The supporting bracket and the first connecting assembly rotate to each other with a first rotational axis. The second connecting assembly has a fifth portion and a sixth portion. The fifth portion connects with the second portion. The sixth portion is fixed with the second machine body. The supporting bracket and the second connecting assembly rotate to each other with a second rotational axis.

The invention further provides an electronic apparatus, which includes a first machine body, a second machine body, at least one supporting bracket, a first connecting assembly, and a second connecting assembly. In the invention, the second machine body is disposed opposed to the first machine body. The supporting bracket has a first portion and a second portion. The first connecting assembly has a third portion and a fourth portion. The third portion connects with the first portion. The fourth portion is fixed with the first machine body. The supporting bracket and the first connecting assembly rotate to each other with a first rotational axis. The second connecting assembly has a fifth portion and a sixth portion. The fifth portion connects with the second portion. The sixth portion is fixed with the second machine body. The supporting bracket and the second connecting assembly rotate to each other with a second rotational axis.

As mentioned above, the hinge structure and electronic apparatus of the invention have a first connecting assembly and a second connecting assembly. Compared to the prior art, the hinge structure and electronic apparatus of the invention have two rotational axes, which are disposed between the first machine body and the second machine body and are consisted by the first connecting assembly and the second connecting assembly. The user can use the first connecting assembly and the second connecting assembly individually or simultaneously to adjust the relative distance and angle between the first machine body and the second machine body. Therefore, there is more space to be adjusted for the users to get a better view. Moreover, it is more convenient to adjust the relative distance and angles on user's demand.

### BRIEF DESCRIPTION OF THE DRAWINGS

The invention will become more fully understood from the detailed description given herein below illustrations only, and thus is not limitative of the present invention, and wherein:

FIG. 1 is a schematic view of the conventional notebook and its hinge;

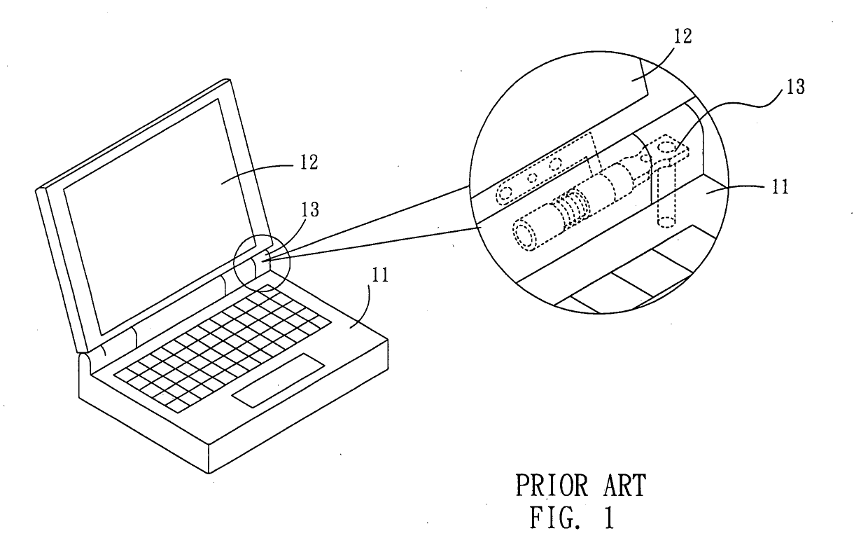

FIG. 2 is a schematic view of the hinge structure of the invention;

FIG. 3 is a schematic view of the hinge structure and electronic apparatus of the invention;

FIG. 4 is another schematic view of the hinge structure and electronic apparatus of the invention; and

FIG. 5 is an exploded schematic view of the hinge structure and electronic apparatus of the invention.

### DETAILED DESCRIPTION OF THE INVENTION

The hinge structure and electronic apparatus according to preferred embodiments of the invention will be described herein below with reference to the accompanying drawings, wherein the same reference numbers refer to the same elements.

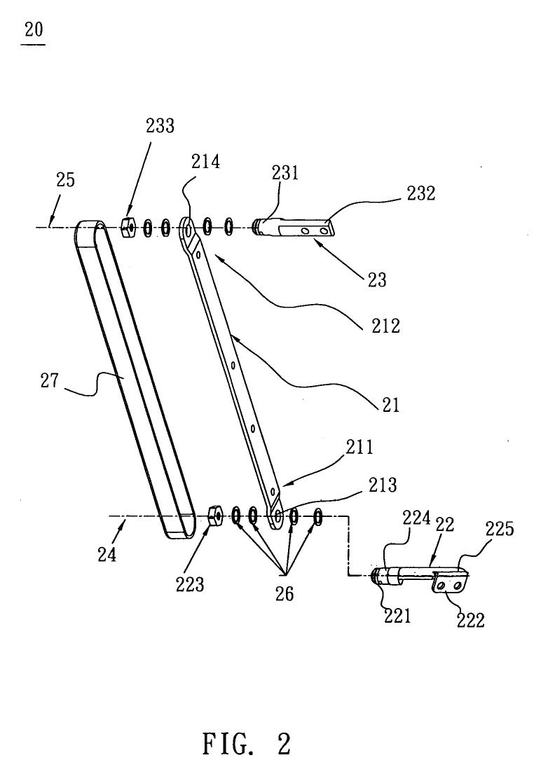

First, referring to FIG. 2 to FIG. 4, the hinge structure according to a preferred embodiment of the invention will be described.

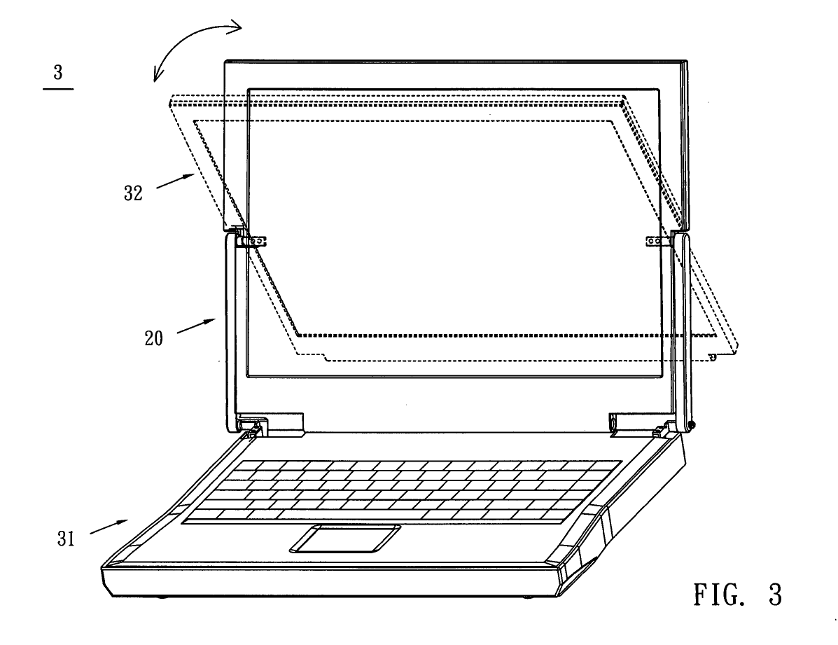

As shown in FIG. 2 and FIG. 3, a hinge structure 20 is for connecting a first machine body 31 and a second machine body 32. The hinge structure 20 includes a supporting bracket 21, a first connecting assembly 22, and a second connecting assembly 23.

According to FIG. 3, the hinge structure 20 disposed in a notebook is taken for example in the current embodiment. The first machine body 31 can be a mainframe, and the second machine body 32 can be a display. Of course, the hinge structure 20 is not limited to being disposed in the notebook; it can be disposed in other electronic apparatus, such as mobile phone, liquid crystal television, and personal digital assistance (PDA).

In FIG. 2, the supporting bracket 21 has a first portion 211 and a second portion 212. In this embodiment, the supporting bracket 21 further comprising a first through hole 213, and a second through hole 214, the first through hole 213 is disposed at the first portion 211 and the second through hole 214 is disposed at the second portion 212.

As shown in FIG. 2 and FIG. 3, the first connecting assembly 22 has a third portion 221 and a fourth portion 222. The third portion 221 connects with the first portion 211 and the fourth portion 222 is fixed with the first machine body 31. The supporting bracket 21 and the first connecting assembly 22 rotate to each other with a first rotational axis 24. Consequently, the fist machine body 31 fixed on the fourth portion 22 also can rotate relatively with the first rotational axis 24. In this case, the fourth portion 222 of the first connecting assembly 22 can be designed to variety of shapes, such as L-shape, according to real arrangement.

In the current embodiment, the first connecting assembly 22 further comprising a first locking member 223, at least one part of the third portion 221 passes through the first through hole 213, and engages with the first locking member 223. The first locking member 223 can be a nut and engages with the third portion 221 of the first connecting assembly 22.

Besides, the first connecting assembly 22 has a first member 224 and a second member 225, the first member 224 and the second member 225 are pivoted to each other. Therefore, the first connecting assembly 22 becomes a hinge, even a multi-level hinge, which is for strengthening the frictional force, structure strength, and assisting to support the weight of the second machine body 32.

The second connecting assembly 23 has a fifth portion 231 and a sixth portion 232. The fifth portion 231 connects with the second portion 212. The sixth portion 232 is fixed with the second machine body 32. The supporting bracket 21 and the second connecting assembly 23 rotate to each other with a second rotational axis 25. Consequently, the second connecting assembly 23 fixed to the second machine body 32 can rotate relatively with the second rotational axis 25. In this case, the sixth portion 232 of the second connecting assembly 23 can be designed to variety of shapes, such as L-shape, according to real arrangement.

In the current embodiment, the second connecting assembly 23 further comprising a second locking member 233, at least one part of the fifth portion 231 passes through the second through hole 214, and engages with the second locking member 233. The second locking member 233 can be a nut and engages with the fifth portion 231 of the second connecting assembly 23.

In this embodiment, the first connecting assembly 22 and the second connecting assembly 23 has a plurality of washers 26 respectively, which are passed through by the third portion 221 and the fifth portion 231. Moreover, they can be disposed on two side of the first through hole 213 and the second through hole 214. In this case, the washers can be spring washers, which is for providing the frictional force between the supporting bracket 21, the first connecting assembly 22 and the first connecting assembly 23.

Moreover, the hinge structure 20 further comprising a cover body 27 (shown in FIG. 2), which covers the jointed part of the supporting bracket 21, the first connecting assembly 22 and the second connecting assembly 23. Consequently, the hinge structure 20 could have a more beautiful style.

By the connection between the fourth portion. 222 of the first connecting assembly 22 and the first machine body 31, and by the connection between the sixth portion 232 of the second connecting assembly 23, there are two rotational axis between the first machine body 31 and the second machine 32. The two axes can be provided for adjusting the angle and the relative distance between the first machine body 31 and the second machine body 32.

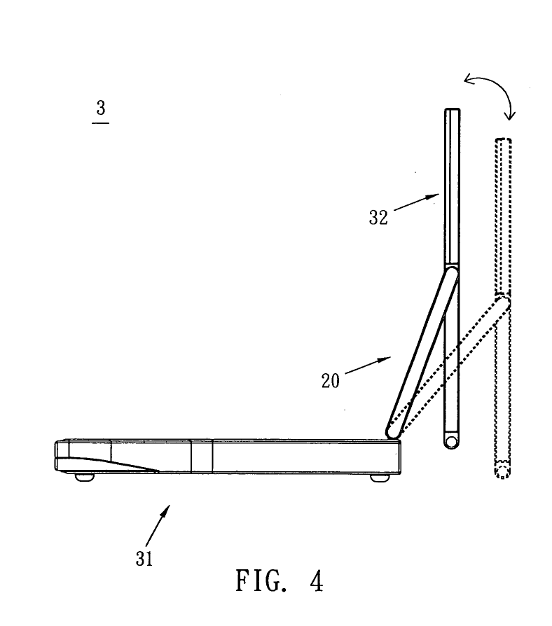

According to FIG. 3 and FIG. 4, the users can use the first connecting assembly 22 to adjust the relative distance between the first machine body 31 and the second machine body 32. Moreover, they also can use the second connecting assembly 23 to adjust the relative angle between the first machine body 31 and the second machine body 32. Therefore, there is more space to be adjusted for the users to get a better view. And it is more convenient to adjust the relative distance and angles on user's demand.

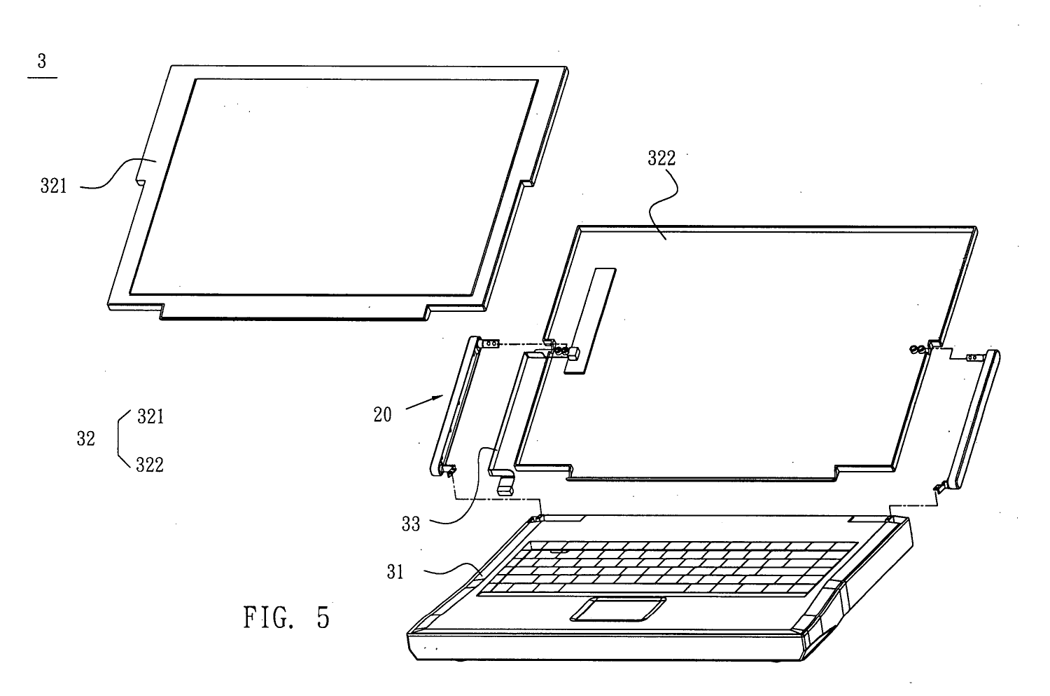

Secondly, referring to FIG, 2 to FIG. 5, the electronic apparatus 3 according to a preferred embodiment of the invention will be described.

As shown in to FIG. 2 to FIG. 5, the electronic apparatus 3 includes a first machine body 31, a second machine body 32, at least one supporting bracket 21, a first connecting assembly 22, and a second connecting assembly 23. In this case, the supporting bracket 21, the first connecting assembly 22, and the second connecting assembly 23 are called a hinge structure 20.

The electronic apparatus 3 can be a notebook, a mobile phone, liquid crystal television, personal digital assistance (PDA) or other portable information processing device. In this embodiment, the electronic apparatus 3 is for example, a notebook. The first machine body 31 can be a mainframe, and the second machine body can be a display. Of course, the first machine body 31 can be a display, and the second machine body can be a mainframe. The second machine body 32 includes an upper lid and a module circuit board 322.

According to FIG. 5, the electronic apparatus 3 further comprises a wiring 33, which is disposed along the supporting bracket 21 and is electrically connected with the first machine body 31 and the second machine body 32. The wiring 33 can be a flexible printed circuit (FPC). One end of the wiring 33 is disposed on the first machine body 31 and the other end is disposed on the module circuit board of the second machine body 32, which is for connecting the signal between the mainframe and the display.

In FIG. 2, the supporting bracket 21 has a first portion 211 and a second portion 212. In this embodiment, the supporting bracket 21 further comprising a first through hole 213, and a second through hole 214, the first through hole 213 is disposed at the first portion 211 and the second through hole 214 is disposed at the second portion 212.

As shown in FIG. 2 and FIG. 3, the first connecting assembly 22 has a third portion 221 and a fourth portion 222. The third portion 221 connects with the first portion 211 and the fourth portion 222 is fixed with the first machine body 31. The supporting bracket 21 and the first connecting assembly 22 rotate to each other with a first rotational axis 24. Consequently, the fist machine body 31 fixed on the fourth portion 22 also can rotate relatively with the first rotational axis 24. In this case, the fourth portion 222 of the first connecting assembly 22 can be designed to variety of shapes, such as L-shape, according to real arrangement.

In the current embodiment, the first connecting assembly 22 further comprising a first locking member 223, at least one part of the third portion 221 passes through the first through hole 213, and engages with the first locking member 223. The first locking member 223 can be a nut and engages with the third portion 221 of the first connecting assembly 22.

Besides, the first connecting assembly 22 has a first member 224 and a second member 225, the first member 224 and the second member 225 are pivoted to each other. Therefore, the first connecting assembly 22 becomes a hinge, even a multi-level hinge, which is for strengthening the frictional force, structure strength, and assisting to support the weight of the second machine body 32.

The second connecting assembly 23 has a fifth portion 231 and a sixth portion 232. The fifth portion 231 connects with the second portion 212. The sixth portion 232 is fixed with the second machine body 32. The supporting bracket 21 and the second connecting assembly 23 rotate to each other with a second rotational axis 25. Consequently, the second connecting assembly 23 fixed to the second machine body 32 can rotate relatively with the second rotational axis 25. In this case, the sixth portion 232 of the second connecting assembly 23 can be designed to variety of shapes, such as L-shape, according to real arrangement.

In the current embodiment, the second connecting assembly 23 further comprising a second locking member 233, at least one part of the fifth portion 231 passes through the second through hole 214, and engages with the second locking member 233. The second locking member 233 can be a nut and engages with the fifth portion 231 of the second connecting assembly 23.

In this embodiment, the first connecting assembly 22 and the second connecting assembly 23 has a plurality of washers 26 respectively, which are passed through by the third portion 221 and the fifth portion 231. Moreover, they can be disposed on two side of the first through hole 213 and the second through hole 214. In this case, the washers are providing the frictional force between the supporting bracket 21, the first connecting assembly 22 and the first connecting assembly 23.

Moreover, the electronic apparatus 3 further comprising a cover body 27 (shown in FIG. 2), which covers the supporting bracket 21, the first connecting assembly 22 and the second connecting assembly 23. Consequently, the hinge structure 20 could have a more beautiful style.

By the connection between the fourth portion 222 of the first connecting assembly 22 and the first machine body 31, and by the connection between the sixth portion 232 of the second connecting assembly 23, there are two rotational axis between the first machine body 31 and the second machine 32. The two axis can be provided for adjusting the angle and the relative distance between the first machine body 31 and the second machine body 32.

According to FIG. 3 and FIG. 4, the users can use the first connecting assembly 22 to adjust the relative distance between the first machine body 31 and the second machine body 32. Moreover, they also can use the second connecting assembly 23 to adjust the relative angle between the first machine body 31 and the second machine body 32. Therefore, there is more space to be adjusted for the users to get a better view. And it is more convenient to adjust the relative distance and angles on user's demand.

As mentioned above, the hinge structure and electronic apparatus of the invention has a first connecting assembly and a second connecting assembly. Compared to the prior art, the hinge structure and electronic apparatus of the invention have two rotational axes, which are disposed between the first machine body and the second machine body and are connected by the first connecting assembly and the second connecting assembly. The user can use the first connecting assembly and the second connecting assembly individually or simultaneously to adjust the relative distance and angle between the first machine body and the second machine body. Therefore, there is more space to be adjusted for the users to get a better view. Moreover, it is more convenient to adjust the relative distance and angles on user's demand.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A hinge structure, which is for connecting a first machine body and a second machine body, comprising:
a supporting bracket having a first portion and a second portion;
a first connecting assembly having a third portion and a fourth portion, wherein the third portion connects with the first portion, the fourth portion is fixed with the first machine body, and the supporting bracket and the first connecting assembly rotate to each other with a first rotational axis; and
a second connecting assembly having a fifth portion and a sixth portion, wherein the fifth portion connects with the second portion, the sixth portion is fixed with the second machine body, and the supporting bracket and the second connecting assembly rotate to each other with a second rotational axis.

2. The hinge structure of claim 1, wherein the supporting bracket further including a first through hole disposed at the first portion and a second through hole disposed at the second portion.

3. The hinge structure of claim 2, wherein the first connecting assembly further includes a first locking member, and at least one part of the third portion passes through the first through hole and engages with the first locking member.

4. The hinge structure of claim 2, wherein the second connecting assembly further includes a second locking member, and at least one part of the fifth portion passes through the second through hole and engages with the second locking member.

5. The hinge structure of claim 1, wherein the first connecting assembly has a first member and a second member, and the first member and the second member are pivoted to each other.

6. The hinge structure of claim 1, wherein the first connecting assembly and the second connecting assembly have at least one washer respectively, and the washer is passed through by the third portion or the fifth portion.

7. The hinge structure of claim 6, wherein the washer is a spring washer.

8. The hinge structure of claim 6, further comprising a cover body covering a jointed part of the supporting bracket.

9. The hinge structure of claim 1, wherein the first machine body is a mainframe, and the second machine body is a display.

10. A electronic apparatus, comprising:
a first machine body;
a second machine body disposed opposite to the first machine body;
at least one supporting bracket having a first portion and a second portion;
a first connecting assembly having a third portion and a fourth portion, wherein the third portion connects with the first portion, the fourth portion is fixed with the first machine body, and the supporting bracket and the first connecting assembly rotate to each other with a first rotational axis; and
a second connecting assembly having a fifth portion and a sixth portion, wherein the fifth portion connects with the second portion, the sixth portion is fixed with the second machine body, and the supporting bracket and the second connecting assembly rotate to each other with a second rotational axis.

11. The electronic apparatus of claim 10, wherein the supporting bracket further including a first through hole disposed at the first portion and a second through hole disposed at the second portion.

12. The electronic apparatus of claim 11, wherein the first connecting assembly further includes a first locking member, and at least one part of the third portion passes through the first through hole and engages with the first locking member.

13. The electronic apparatus of claim 11, wherein the second connecting assembly further includes a second locking member, and at least one part of the fifth portion passes through the second through hole and engages with the second locking member.

14. The electronic apparatus of claim 10, wherein the first connecting assembly is a hinge.

15. The electronic apparatus of claim 10, wherein the first connecting assembly and the second connecting assembly have at least one washer respectively, and the washer is passed through by the third portion or the fifth portion.

16. The electronic apparatus of claim 15, wherein the washer is a spring washer.

17. The electronic apparatus of claim 10, further comprising a cover body covering a jointed part of the supporting bracket.

18. The electronic apparatus of claim 10, further comprising a wiring disposed along the supporting bracket and electrically connected with the first machine body and the second machine body.
